(19) United States
(12) Patent Application Publication
(10) Pub. No.: US 2024/0117153 A1
(43) Pub. Date: Apr. 11, 2024

(54) SANDWICH PANEL FOR AUTOMOBILE, MANUFACTURING METHOD THEREOF, AND UPPER COVER FOR AUTOMOBILE BATTERY PACK COMPRISING SAME

(71) Applicants: Hyundai Motor Company, Seoul (KR); Kia Corporation, Seoul (KR); LX HAUSYS, Ltd., Seoul (KR)

(72) Inventors: Duck Hyoung HWANG, Seoul (KR); Hyun Jun KIM, Hwaseong-si (KR); Hyo Sang AHN, Suwon (KR); Sang Hyun RHO, Seoul (KR); Suk JANG, Seoul (KR); Myung LEE, Seoul (KR); Da Young YU, Seoul (KR); Hyun Jin CHOI, Seoul (KR); Do Hyoung KIM, Seoul (KR); Chan Ho JUNG, Seoul (KR)

(21) Appl. No.: 18/297,314

(22) Filed: Apr. 7, 2023

(30) Foreign Application Priority Data
Oct. 11, 2022 (KR) 1020220129921

(51) Int. Cl. C08K 7/14; B32B 5/02; B32B 7/12; B32B 15/14; B32B 15/20; B32B 37/12; C09J 123/02

(52) U.S. Cl. CPC C08K 7/14; B32B 5/02; B32B 7/12; B32B 15/14; B32B 15/20; B32B 37/12; C09J 123/02; B32B 2255/02; B32B 2255/26; B32B 2260/021; B32B 2260/046; B32B 2262/101; B32B 2307/3065; B32B 2307/546; B32B 2307/718; B32B 2307/7376; B32B 2315/085; B32B 2457/10; B32B 2605/00

(57) ABSTRACT

A sandwich panel for an automobile includes a core layer, a surface layer, and an adhesive layer. The core layer includes glass fibers and thermoplastic resins and defines an optimal weight and thickness to provide flexural performance and non-flammability. The sandwich panel provides a flame barrier layer, which is a non-combustible layer during ignition and prevents flame from leaking to the outside of the panel.

### CROSS-REFERENCE TO RELATED APPLICATION

This application claims, under 35 U.S.C. § 119(a), the benefit of priority from Korean Patent Application No. 10-2022-0129921, filed on Oct. 11, 2022, the entire contents of which are incorporated herein by reference.

### TECHNICAL FIELD

The present disclosure relates to a sandwich panel for an automobile, a manufacturing method thereof, and an upper cover for an automobile battery pack including the same.

### BACKGROUND

An upper cover for an automobile battery pack may be manufactured using steel or thermosetting resin-based composite materials. Steel, which is most commonly used for the upper cover for an automobile battery pack, has a unit weight of 4.7 kg/m² or more and is thus heavy, and has low thickness, thus exhibiting low structural rigidity, and as such, there is a disadvantage in that flexure occurs in case of fire and flame may be exposed through gaps. Although a thermosetting resin enables weight reduction, a separate barrier layer may be applied or carbon fiber may be used for electromagnetic shielding performance, and the weight thereof increases when inorganic materials are used to attain fire resistance performance.

A typical sandwich structure material having high structural rigidity and excellent fire resistance performance is a high-density polyethylene (HDPE)-foam-based aluminum composite panel. The composite panel is widely applied mainly for building exteriors. Since it is difficult to ensure a limited-combustible grade or higher when applying a general HDPE foam core, fire resistance performance of a limited-combustible grade or higher may be obtained only by adding inorganic materials. The composite panel may not be suitable as an upper cover for an automobile battery pack because the unit weight thereof is increased compared to steel when inorganic materials are added thereto.

### SUMMARY OF THE DISCLOSURE

The present disclosure has been made keeping in mind the problems encountered in the related art, and an object of the present disclosure is to provide a sandwich panel for an automobile, in which a glass-fiber-based flame barrier layer is formed due to an increase in the thickness of a coating layer in case of fire, and as such, fire in the battery pack is not exposed to the outside, making it possible to ensure 5 minutes or more as the time required for evacuation of passengers.

Another object of the present disclosure is to provide an upper cover for an automobile battery pack having a weight reduced by 30% compared to steel that is the existing upper cover material for an automobile battery pack, thereby improving energy efficiency.

The objects of the present disclosure are not limited to the foregoing. The objects of the present disclosure will be able to be clearly understood through the following description and to be realized by the means described in the claims and combinations thereof.

The present disclosure provides a sandwich panel for an automobile, including a core layer in a sheet form and including a glass fiber and a thermoplastic resin, a surface layer disposed on at least one surface of the core layer, and an adhesive layer configured to attach the core layer and the surface layer to each other.

The thermoplastic resin can surround the surface of the glass fiber.

The core layer can be converted into a non-combustible layer by carbonizing the thermoplastic resin upon ignition.

The core layer can expand by 200% or more in the thickness direction of the sandwich panel upon ignition.

The thermoplastic resin can include at least one selected from the group consisting of polyethylene, polypropylene, polyethylene terephthalate, polytrimethylene terephthalate, polybutylene terephthalate, polyethylene naphthalate, polyamide, polyphenylene sulfide, and combinations thereof.

The core layer can include, based on the total weight of the core layer, 40 wt % to 60 wt % of the glass fiber and 40 wt % to 60 wt % of the thermoplastic resin.

The weight per unit area of the core layer can be 0.6 kg/m² to 1.0 kg/m².

The thickness of the core layer can be 0.8 mm to 1.2 mm.

The surface layer can include at least one selected from the group consisting of aluminum, iron, stainless steel (SUS), magnesium, electro-galvanized iron (EGI), galvanized iron (GI), and combinations thereof.

The thickness of the surface layer can be 0.4 mm to 0.6 mm.

The adhesive layer can include at least one selected from the group consisting of polyethylene, polypropylene, amorphous polyalphaolefin adhesives, and combinations thereof.

The thickness of the adhesive layer can be 50 μm to 100 μm.

The sandwich panel can have a thickness of 1.25 mm to 2.4 mm.

The sandwich panel can have a weight per unit area of 2.8 kg/m² to 3.5 kg/m².

In addition, the present disclosure provides an upper cover for an automobile battery pack including the sandwich panel described above.

In addition, the present disclosure provides a method of manufacturing a sandwich panel for an automobile, including obtaining a mixed fiber by mixing a glass fiber and a thermoplastic resin, obtaining a core layer including a substrate obtained by carding the mixed fiber and performing needle punching, forming an adhesive layer on one surface of the core layer, and forming a surface layer on the adhesive layer.

### BRIEF DESCRIPTION OF THE DRAWINGS

FIG. 1 schematically shows an example of a sandwich panel for an automobile.

FIG. 2 schematically shows the flame retardant function of the sandwich panel for an automobile.

FIG. 3 is a flowchart schematically showing an example process for manufacturing a sandwich panel for an automobile.

### DETAILED DESCRIPTION

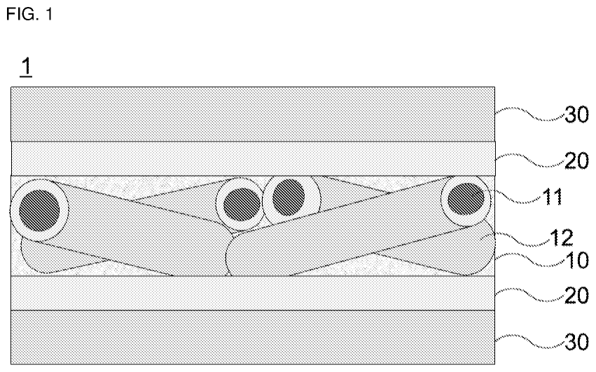

FIG. 1 schematically shows a sandwich panel for an automobile according to the present disclosure.

In some implementations, with reference to FIG. 1, a sandwich panel 1 for an automobile can include a core layer 10, a surface layer 30, and an adhesive layer 20.

Hereinafter, each component will be described in detail.

(a) Core Layer

The core layer 10 according to the present disclosure can be in the form of a sheet. The sheet can be formed of a nonwoven fabric, a web, a woven fabric, and the like. For example, the sheet can be made of a nonwoven fabric. As the nonwoven fabric contains natural pores therein, air permeability and weight reduction can be improved. Since natural pores are formed while fibers are entangled with each other, the core is non-foamable unlike cases in which pores are artificially formed using an additive such as a foaming agent. Thus, the manufacturing cost can be reduced and the foaming process can be obviated, thus increasing processing efficiency. Therefore, formability and processability can be improved compared to conventional thermoplastic or thermosetting foamed resins.

The core layer 10 can include a glass fiber 11 and a thermoplastic resin 12.

For example, the glass fiber 11 can be a fiber having flame retardancy and thus excellent durability without burning even when exposed to fire, or can be processed to have such properties. Since the glass fiber 11 is included in the core layer 10, shrinkage or melting of the core layer can be insignificant even after ignition in the event of fire, and excellent flame retardancy can be ensured.

The thermoplastic resin 12 can be a resin capable of changing shape by applying heat again even after shaping by applying heat. By including the thermoplastic resin in the core layer, high elongation and thus superior formability can result, compared to thermosetting resins. In addition to shaping by applying heat again in the form of a sheet, the thermoplastic resin can exhibit superior formability even during cold forming, and thus has the advantage of low material cost compared to thermosetting resins.

The thermoplastic resin 12 can include at least one selected from the group consisting of polyethylene, polypropylene, polyethylene terephthalate, polytrimethylene terephthalate, polybutylene terephthalate, polyethylene naphthalate, polyamide, polyphenylene sulfide, and combinations thereof. For example, thermoplastic resin 12 includes polypropylene.

With reference to FIG. 1, the thermoplastic resin 12 can surround the surface of the glass fiber 11. Specifically, the thermoplastic resin 12 can be applied onto the surface of the glass fiber 11. Also, the thermoplastic resin 12 can be distributed more richly than the fibers at intersections where glass fibers 11 meet. Thereby, the core layer 10 can be converted into a non-combustible layer by carbonizing the thermoplastic resin 12 when ignited. When the core layer 10 is converted into the non-combustible layer in this way, a single layer of glass fiber is formed. Here, since the glass fiber is flame retardant, it is possible to prevent flame from leaking to the outside of the battery pack, thereby ensuring evacuation time for passengers in case of fire.

Also, the core layer 10 can expand by 200% or more in the thickness direction of the sandwich panel when ignited. When the thickness of the panel is increased due to expansion, structural rigidity can be enhanced by suppressing flexure of the panel.

The core layer 10 can include 40 wt % to 60 wt % of the glass fiber and 40 wt % to 60 wt % of the thermoplastic resin based on the total weight of the core layer. If the amount of the glass fiber is less than 40 wt %, the effect of the present disclosure cannot be obtained due to perforation during fireproofing. On the other hand, if the amount of the glass fiber is greater than 60 wt %, the sandwich structure can collapse due to insufficient bonding strength of the glass fiber, resulting in reduced flexural rigidity.

The weight per unit area of the core layer 10 can be 0.6 kg/m² to 1.0 kg/m². Conventionally, HDPE foam was used as a material for the core layer, making it difficult to obtain a limited-combustible grade or higher, and thus, it was possible to obtain fire resistance performance of a limited-combustible grade or higher only by adding inorganic materials. However, the addition of inorganic materials was problematic in that the weight per unit area of the core layer was increased compared to the existing steel.

The weight per unit area of the core layer 10 of the present disclosure is 0.6 kg/m² to 1.0 kg/m², and weight reduction of 30% or more is possible compared to conventional cases. If the weight per unit area of the core layer is less than 0.6 kg/m², the rigidity of the core layer can be decreased, and the density of the core layer can be lowered, and thus fire resistance performance can be deteriorated, such that perforation can occur. On the other hand, if the weight per unit area of the core layer exceeds 1.0 kg/m², weight reduction criteria may not be satisfied, and it is impossible to obtain an appropriate thickness of the product.

The thickness of the core layer 10 is 0.8 mm to 1.2 mm, and weight reduction of 50% or more is possible compared to conventional cases. If the thickness of the core layer is less than 0.8 mm, structural rigidity can be reduced, and thus maximum flexural load can be decreased and deflection can be increased, which is undesirable. On the other hand, if the thickness of the core layer is greater than 1.2 mm, flexural properties can be deteriorated or bonding strength can be lowered when the weight of the core layer is low, and also weight reduction criteria may not be satisfied when the weight of the core layer is high.

The core layer 10 of the present disclosure is very effective at improving energy efficiency by virtue of the weight per unit area and thickness described above.

(b) Surface Layer

The sandwich panel for an automobile according to the present disclosure can include a surface layer 30 disposed on at least one surface of the core layer 10.

The surface layer 30 can be formed of a metal material, and includes at least one selected from the group consisting of aluminum, iron, stainless steel (SUS), magnesium, electro-galvanized iron (EGI), galvanized iron (GI), and combinations thereof. For example, aluminum can used to define the surface layer 30.

The thickness of the surface layer 30 can be 0.4 mm to 0.6 mm. If the thickness of the surface layer is less than 0.4 mm, physical properties of the material, such as surface rigidity, impact strength, and dent resistance, can be deteriorated. On the other hand, if the thickness of the surface layer is greater than 0.6 mm, weight reduction criteria may not be satisfied or material cost can be greatly increased.

(c) Adhesive Layer

The sandwich panel for an automobile according to the present disclosure can include an adhesive layer 20 configured to attach the core layer 10 and the surface layer 30 to each other. The adhesive layer 20 can be applied between the core layer and the surface layer 30 to adhere the core layer 10 to the surface layer 30. The adhesive layer 20 can be applied at a uniform thickness in consideration of viscosity.

The adhesive layer 20 can include at least one selected from the group consisting of polyethylene, polypropylene, amorphous polyalphaolefin adhesives, and combinations thereof.

The thickness of the adhesive layer 20 can be 50 μm to 100 μm. If the thickness of the adhesive layer is less than 50 μm, peel strength of the core layer and the surface layer can be lowered. On the other hand, if the thickness of the adhesive layer is greater than 100 μm, ignition and flame propagation can occur in case of fire.

The sandwich panel for an automobile according to the present disclosure can have a thickness of 1.25 mm to 2.4 mm. For example, the thickness of the sandwich panel can be 1.8 mm to 2.2 mm.

The sandwich panel for an automobile according to the present disclosure can have a weight of 2.8 kg/m² to 3.5 kg/m².

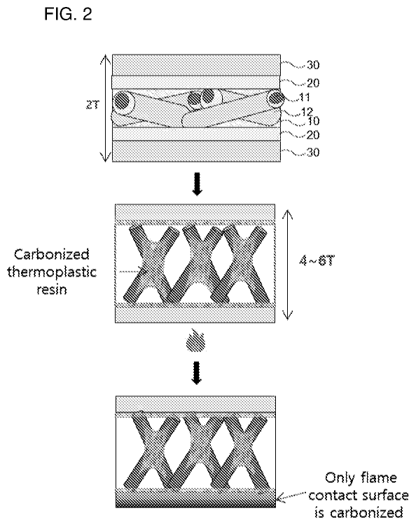

The sandwich panel for an automobile according to the present disclosure has flame retardancy. FIG. 2 schematically shows the flame retardant function of the sandwich panel for an automobile according to the present disclosure. With reference to FIG. 2, when fire occurs outside the sandwich panel for an automobile according to the present disclosure, the thermoplastic resin is melted and expands in the thickness direction of the sandwich panel due to elasticity of the glass fiber. Thereafter, the thermoplastic resin is carbonized to thus form a non-combustible layer, which is a single layer of glass fiber, thereby suppressing flame propagation by virtue of the thermal insulation effect due thereto. Briefly, the thickness of the panel can be increased, and thus structural rigidity can be enhanced and flexure can be suppressed.

Another aspect of the present disclosure pertains to an upper cover for an automobile battery pack including the sandwich panel described above.

Below is a detailed description of a method of manufacturing the sandwich panel for an automobile according to the present disclosure. In the manufacturing method, configuration of the core layer, the surface layer, and the adhesive layer is the same as those described above in the sandwich panel for an automobile, and thus a detailed description thereof is omitted.

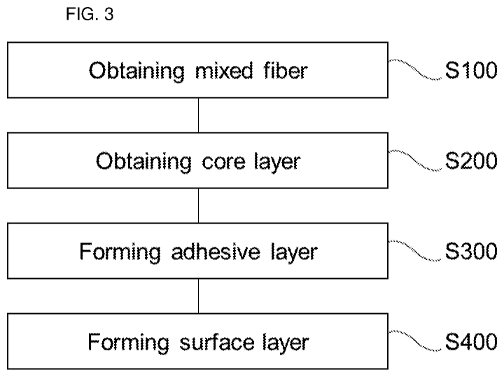

FIG. 3 is a flowchart schematically showing a process of manufacturing the sandwich panel for an automobile according to the present disclosure. With reference to FIG. 3, the method of manufacturing the sandwich panel for an automobile according to the present disclosure includes obtaining a mixed fiber by mixing a glass fiber and a thermoplastic resin (S100), obtaining a core layer including a substrate obtained by carding the mixed fiber and performing needle punching (S200), forming an adhesive layer on one surface of the core layer (S300), and forming a surface layer on the adhesive layer (S400).

First, S100 is a step of obtaining a mixed fiber by mixing a glass fiber and a thermoplastic resin.

In S100, a mixed fiber can be obtained by applying the thermoplastic resin onto the surface of the glass fiber. Specifically, the core layer is manufactured in the form of a board by applying heat and pressure thereto, and raw materials are prepared in a state in which glass fiber and thermoplastic resin are mixed, and when heat and pressure are applied thereto, the thermoplastic resin is applied onto the glass fiber.

Thereby, the thermoplastic resin can be distributed richly at intersections where glass fibers meet.

Next, S200 is a step of obtaining a core layer including a substrate obtained by carding the mixed fiber and performing needle punching.

The carding can be performed without any particular limitation, so long as it is a carding process used in the art.

The mixed fiber can be subjected to typical needle punching 1-5 times to obtain a substrate. If the number of times the process is performed is too low, physical bonding between fibers can be reduced. On the other hand, if the number of times the process is performed is too large, the fiber can be destroyed and problems in physical properties can occur.

The substrate can be a nonwoven fabric.

The substrate can be pressed and heated with a press at a temperature of 180° C. to 220° C. and a pressure of 3 bar to 7 bar for 5 to 15 minutes, followed by cold pressing at a pressure of 3 bar to 7 bar for 3 to 8 minutes, thereby obtaining a core layer.

Next, S300 is a step of forming an adhesive layer on one surface of the core layer.

In S300, an adhesive layer can be formed on one surface of the core layer.

S300 can be performed by applying the adhesive layer on one surface of the core layer. The application process can be conducted using a process selected from among die coating, gravure coating, knife coating, and spray coating.

Finally, S400 is a step of forming a surface layer on the adhesive layer.

In S400, a process selected from among a photocuring process, a thermosetting process, and a hot-pressing process can be performed.

The manufacturing method can further include laminating a stack including the core layer, the adhesive layer, and the surface layer. The lamination can be performed through heating with a press at a temperature of 100° C. to 150° C. and a pressure of 3 bar to 7 bar for 3 to 8 minutes, followed by cooling at a pressure of 3 bar to 7 bar for 2 to 7 minutes, thereby obtaining a sandwich panel for an automobile.

A better understanding of the present disclosure can be obtained through the following examples and comparative examples. However, these examples are not to be construed as limiting the technical spirit of the present disclosure.

### Examples 1 to 4 and Comparative Examples 1 to 4

### Example 1

Glass fiber and polypropylene fiber, which is a thermoplastic resin, were mixed at 4:6 to prepare a mixed fiber. The mixed fiber was carded, bonded about 1-2 times in a needle punching machine, and hot-pressed to obtain a core layer having a thickness of 0.8 mm to 1.2 mm. The core layer, a surface layer that is an aluminum sheet having a thickness of 0.4 mm, and a polyolefin-based adhesive layer having a thickness of 50 μm to 100 μm were stacked and pressed using a press. Ultimately, a sandwich panel for an automobile having a final thickness of 2.0 mm was obtained.

### Example 2

A sandwich panel for an automobile was obtained in the same manner as in Example 1, with the exception that glass fiber and polypropylene fiber, which is a thermoplastic resin, were mixed at 5:5.

### Example 3

A sandwich panel for an automobile was obtained in the same manner as in Example 1, with the exception that glass fiber and polypropylene fiber, which is a thermoplastic resin, were mixed at 6:4.

### Example 4

A sandwich panel for an automobile was obtained in the same manner as in Example 3, with the exception that the thickness of the surface layer was 0.5 mm.

### Comparative Example 1

Steel, which is a 0.6 mm-thick steel sheet having tensile strength of 270 MPa, was used (Product supplied by steel companies such as Hyundai Steel or POSCO).

### Comparative Example 2

A composite panel generally used for construction was manufactured in the form of a roll-to-sheet by building panel manufacturers. This panel was manufactured by extruding 30 wt % of HDPE and 70 wt % of mineral (aluminum trihydroxide) to form a core, the upper and lower skin layers of which were then coated with an adhesive.

### Comparative Example 3

A sandwich panel for an automobile was obtained in the same manner as in Example 1, with the exception that glass fiber and polypropylene fiber, which is a thermoplastic resin, were mixed at 3.5:6.5.

### Comparative Example 4

A sandwich panel for an automobile was obtained in the same manner as in Example 1, with the exception that glass fiber and polypropylene fiber, which is a thermoplastic resin, were mixed at 6.5:3.5.

Examples 1 to 4 and Comparative Examples 1 to 4 The sandwich panels for automobiles manufactured in Examples 1 to 4 and Comparative Examples 1 to 4 were provided at the following weight (according to ASTM D3776) and thickness.

TABLE 1

| | Example | Example | Example | Example | Comparative | Comparative | Comparative | Comparative |
|---|---|---|---|---|---|---|---|---|
| Classification | 1 | 2 | 3 | 4 | Example 1 | Example 2 | Example 3 | Example 4 |
| Weight per | 3.0 | 3.0 | 3.0 | 3.5 | 4.7 | 6.0 | 3.0 | 3.0 |
| unit area | | | | | | | | |
| (kg/m²) | | | | | | | | |
| Panel | 7.6 | 7.6 | 7.6 | 8.9 | 13.1 | 15.2 | 7.6 | 7.6 |
| weight (kg) | | | | | | | | |
| Panel | 2.0 | 2.0 | 2.0 | 2.0 | 0.6 (panel | 3.0 | 2.0 | 2.0 |
| thickness (mm) | | | | | X) | | | |

As shown in Table 1, the final thickness was 2.0 mm in Examples 1 to 4 and Comparative Examples 3 and 4, Comparative Example 1 was 0.6 mm-thick steel, and Comparative Example 2 was a 3.0 mm-thick composite panel.

### Test Example 1: Comparison of Flexural Performance

For the sandwich panels for automobiles manufactured in Examples 1 to 4 and Comparative Examples 1 to 4, maximum load and flexural rigidity were measured. The results thereof are shown in Table 2 below.

[Test Method]
Measurement of maximum load: ASTM C393 (specimen size: 200*50 mm, measurement speed: 6 mm/min, span: 150 mm)
Measurement of flexural rigidity: Deflection measurement after load application (specimen size: 250*75 mm, applied load: 1.8 kg, span: 200 mm)

TABLE 2

| | Example | Example | Example | Example | Comparative | Comparative | Comparative | Comparative |
|---|---|---|---|---|---|---|---|---|
| Classification | 1 | 2 | 3 | 4 | Example 1 | Example 2 | Example 3 | Example 4 |
| Maximum | 159 | 148 | 141 | 172 | 37 | 201 | 128 | 97 |
| load (N) | | | | | | | | |
| Deflection | 1.0 | 1.0 | 1.2 | 0.8 | 11.1 | 0.5 | 0.9 | 4.1 |
| (mm) | | | | | | | | |

As shown in Table 2, Examples 1 to 4 exhibited superior maximum load and deflection compared to Comparative Example 1, which is the conventional technique. Also, in Comparative Examples 3 and 4, since the amount of glass fiber was less than 40 wt % or exceeded 60 wt %, mechanical properties were deteriorated.

### Test Example 2: Comparison of Flammability

For the sandwich panels for automobiles manufactured in Examples 1 to 4 and Comparative Examples 1 to 4, flammability was measured. The results thereof are shown in Table 3 below. The grades in Table 3 were set according to the following criteria.

[Test Method]
Measurement of flammability: UL94 vertical burning test (specimen size: 125*13 mm)

| | V-0 | | V-1 | | V-2 | |
|---|---|---|---|---|---|---|
| Individual afterflame time | ≤10 | sec. | ≤30 | sec. | ≤30 | sec. |
| (t1 or t2) | | | | | | |
| Total afterflame time for any | ≤50 | sec. | ≤250 | sec. | ≤250 | sec. |
| condition set (t1 + t2 for | | | | | | |
| 5 specimens) | | | | | | |
| Afterflame plus afterglow | ≤30 | sec. | ≤60 | sec. | ≤60 | sec. |
| time for each specimen after | | | | | | |
| the second flame application | | | | | | |
| (t2 + t3) | | | | | | |

| | | | |
|---|---|---|---|
| Burning up to the holding | No | No | No |
| clamp (125 mm marked) | | | |
| Cotton ignition through | No | No | Yes |
| dropping | | | |

TABLE 3

| | Example | Example | Example | Example | Comparative | Comparative | Comparative | Comparative |
|---|---|---|---|---|---|---|---|---|
| Classification | 1 | 2 | 3 | 4 | Example 1 | Example 2 | Example 3 | Example 4 |
| Individual | 14 | 10 | 0 | 0 | 0 | 0 | 15 | 0 |
| afterflame | | | | | | | | |
| time (sec) | | | | | | | | |
| Total | 71 | 22 | 0 | 0 | 0 | 0 | 73 | 0 |
| afterflame | | | | | | | | |
| time (sec) | | | | | | | | |
| Glowing time | 14 | 0 | 0 | 0 | 0 | 0 | 14 | 0 |
| (sec) | | | | | | | | |
| Burning up to | X | X | X | X | X | X | X | X |
| the holding | | | | | | | | |
| clamp | | | | | | | | |
| Cotton | X | X | X | X | X | X | X | X |
| ignition | | | | | | | | |
| Grade | V-0 | V-0 | V-0 | V-0 | V-0 | V-0 | V-2 | V-0 |

As shown in Table 3, in Comparative Example 3, the amount of glass fiber was 35 wt % and was thus less than 40 wt % corresponding to the amount range of the glass fiber according to the present disclosure, confirming that fire resistance performance was deteriorated.

### Test Example 3: Limited-Combustible Test

For the sandwich panels for automobiles manufactured in Examples 1 to 4 and Comparative Examples 1 to 4, a limited-combustible test was conducted. The results thereof are shown in Table 4 below.
Test Method: ISO 5660-1 Cone calorimeter (specimen size: 100*100 mm, measurement temperature: 700-800° C., measurement time: 10 minutes)
Limited-combustible (grade 2) criteria: THR (total heat release) of 8 MJ/m² or less (for 10 minutes), peak HRR (heat release rate) of 10 seconds (time exceeding 200 kW/m²)

TABLE 4

| | | | | | Comparative | Comparative | Comparative | Comparative |
|---|---|---|---|---|---|---|---|---|
| Classification | Example 1 | Example 2 | Example 3 | Example 4 | Example 1 | Example 2 | Example 3 | Example 4 |
| THR (600 sec, | 1.8 | 1.5 | 0.8 | 0.5 | 0 | 0.5 | 3.0 | 0.7 |
| MJ/m²) | | | | | | | | |
| Peak HRR (time | 0 | 0 | 0 | 0 | 0 | 0 | 0 | 0 |
| exceeding 200 | | | | | | | | |
| kW/m², sec) | | | | | | | | |
| Grade | Limited- | Limited- | Limited- | Limited- | Limited- | Limited- | Limited- | Limited- |
| | combustible | combustible | combustible | combustible | combustible | combustible | combustible | combustible |

As shown in Table 4, it can be confirmed that all materials had limited-combustible grade.

### Test Example 4: Fire Resistance Test

For the sandwich panels for automobiles manufactured in Examples 1 to 4 and Comparative Examples 1 to 4, a fire resistance test was conducted. The results thereof are shown in Table 5 below.
Test Method: Simple torch test (specimen size: 200*200 mm, test temperature: 1150° C., test time: 600 seconds)

TABLE 5

| | | | | Example | Comparative | Comparative | Comparative | Comparative |
|---|---|---|---|---|---|---|---|---|
| Classification | Example 1 | Example 2 | Example 3 | 4 | Example 1 | Example 2 | Example 3 | Example 4 |
| Top | No | No | No | No | Discoloration | No | No | No |
| discoloration | | | | | | | | |
| Bottom | Perforation | Perforation | Perforation | No | No | Perforation | Perforation | Perforation |
| perforation | | | | | | | | |
| (flame | | | | | | | | |
| application) | | | | | | | | |
| Flame | ∘ | ∘ | ∘ | ⊚ | Δ | Δ | ∘ | ∘ |
| resistance | | | | | | | | |

Flame resistance criteria: ⊚ - excellent, ∘ - good, Δ - fair (there is no perforation in material due to flame, but there is damage to material)

As shown in Table 5, flame resistance is determined based on material perforation, smoke, flame, and the like. It can be confirmed that Examples 1 to 3 were good, and in particular, Example 4 was excellent in perforation, smoke, and flame performance.

Therefore, the sandwich panel for an automobile according to the present disclosure includes a core layer, a surface layer, and an adhesive layer, and glass fiber and thermoplastic resin are included in appropriate amounts in the core layer, thereby realizing an optimal weight and thickness, resulting in superior flexural performance, flammability, etc. Therefore, a flame barrier layer, which is a non-combustible layer, is formed during ignition, making it possible to prevent flame from leaking to the outside.

As is apparent from the above description, a sandwich panel for an automobile according to the present disclosure has improved fire safety, and is capable of increasing fire resistance performance when applied to an upper cover for an automobile battery pack, thereby ensuring evacuation time for passengers in case of fire.

The sandwich panel for an automobile according to the present disclosure can exhibit increased assembly convenience and thus enhanced structural rigidity compared to the existing upper cover material for a battery pack, namely steel.

The sandwich panel for an automobile according to the present disclosure has improved stability, making it possible to minimize the influence of external temperature changes by minimizing interference between parts and improving thermal insulation performance.

The sandwich panel for an automobile according to the present disclosure has improved energy efficiency by reducing the weight of parts by about 30%, thereby increasing mileage when applied to an electric vehicle battery.

The effects of the present disclosure are not limited to the above-mentioned effects. It should be understood that the effects of the present disclosure include all effects that can be inferred from the description of the present disclosure.

Although specific embodiments of the present disclosure have been described with reference to the accompanying drawings, those skilled in the art will appreciate that the present disclosure can be embodied in other specific forms without changing the technical spirit or essential features thereof. Thus, the embodiments described above should be understood to be non-limiting and illustrative in every way.

What is claimed is:

1. A sandwich panel for an automobile, comprising:
a core layer that defines a sheet form, the core layer comprising a glass fiber and a thermoplastic resin;
a surface layer disposed on at least one surface of the core layer; and
an adhesive layer that attaches the core layer and the surface layer to each other.

2. The sandwich panel of claim 1, wherein the thermoplastic resin comprises at least one of polyethylene, polypropylene, polyethylene terephthalate, polytrimethylene terephthalate, polybutylene terephthalate, polyethylene naphthalate, polyamide, polyphenylene sulfide, or any combination thereof.

3. The sandwich panel of claim 1, wherein the thermoplastic resin surrounds the glass fiber.

4. The sandwich panel of claim 1, wherein the core layer is configured to be converted into a non-combustible layer based on the thermoplastic resin being carbonized upon ignition.

5. The sandwich panel of claim 1, wherein the core layer is configured to expand by 200% or more in a thickness direction of the sandwich panel upon ignition.

6. The sandwich panel of claim 1, wherein each of the glass fiber and the thermoplastic resin amounts to 40 wt % to 60 wt % of a total weight of the core layer.

7. The sandwich panel of claim 1, wherein a weight per unit area of the core layer is 0.6 kg/m² to 1.0 kg/m².

8. The sandwich panel of claim 1, wherein a thickness of the core layer is 0.8 mm to 1.2 mm.

9. The sandwich panel of claim 1, wherein the surface layer comprises at least one of aluminum, iron, stainless steel (SUS), magnesium, electro-galvanized iron (EGI), galvanized iron (GI), or any combination thereof.

10. The sandwich panel of claim 1, wherein a thickness of the surface layer is 0.4 mm to 0.6 mm.

11. The sandwich panel of claim 1, wherein the adhesive layer comprises at least one of polyethylene, polypropylene, amorphous polyalphaolefin adhesives, or any combination thereof.

12. The sandwich panel of claim 1, wherein a thickness of the adhesive layer is 50 μm to 100 μm.

13. The sandwich panel of claim 1, wherein a thickness of the sandwich panel is 1.25 mm to 2.4 mm.

14. The sandwich panel of claim 1, wherein a weight per unit area of the sandwich panel is 2.8 kg/m² to 3.5 kg/m².

15. An upper cover for an automobile battery pack, the upper cover comprising the sandwich panel of claim 1.

16. A method for manufacturing a sandwich panel for an automobile, the method comprising:
obtaining a mixed fiber that includes a glass fiber and a thermoplastic resin;
obtaining a core layer, wherein obtaining the core layer comprises obtaining a substrate by performing a carding process and a needle punching process with the mixed fiber;
forming an adhesive layer on a surface of the core layer; and
forming a surface layer on the adhesive layer.

17. The method of claim 16, wherein each of the glass fiber and the thermoplastic resin amounts to 40 wt % to 60 wt % of a total weight of the core layer.

18. The method of claim 16, wherein a weight per unit area of the core layer is 0.6 kg/m² to 1.0 kg/m².

19. The method of claim 16, wherein a thickness of the core layer is 0.8 mm to 1.2 mm, a thickness of the surface layer is 0.4 mm to 0.6 mm, and a thickness of the adhesive layer is 50 μm to 100 μm.

20. The method of claim 16, wherein a thickness of the sandwich panel is 1.25 mm to 2.4 mm, and a unit weight of the sandwich panel is 2.8 kg/m² to 3.5 kg/m².
